(19) United States
(12) Patent Application Publication
(10) Pub. No.: US 2019/0016511 A1
(43) Pub. Date: Jan. 17, 2019

(54) PROTECTION CONTAINER FOR REMOTE CONTROL

(71) Applicant: Yao-Kun Yang, CHANGHUA COUNTY (TW)

(72) Inventor: Yao-Kun Yang, CHANGHUA COUNTY (TW)

(21) Appl. No.: 15/647,261

(22) Filed: Jul. 12, 2017

(51) Int. Cl. B65D 55/14; B65D 43/02; B65D 85/00; E05B 37/02; E05B 37/00; E05B 65/00

(52) U.S. Cl. CPC B65D 55/14; B65D 43/0231; B65D 85/70; B65D 2543/00537; E05B 37/0034; E05B 65/0075; E05B 37/02

(57) ABSTRACT

A protection container for remote controls includes a magnetic-proof container having a room defined therein. A first flange extends upward from the top opening of the container and two paths defined in outside of the first flange. Two holes each are defined through the first flange and located between two respective ends of the two paths. A magnetic-proof cover is removably mounted to the top opening of the container 1 and includes a second flange and a protrusion on the underside thereof. A groove is defined between the second flange and the protrusion. A lock unit is located in the protrusion and accessed from the cover so as to control two insertions to retractably engage with the two holes when the cover is mounted to the container. Remotes are stored in the container, and the cover is openable by operating the lock unit.

### BACKGROUND OF THE INVENTION

### 1. Fields of the Invention

The present invention relates to a protection container, and more particularly, to a protection container for protecting remote controls from being magnetically accessed.

### 2. Descriptions of Related Art

The conventional locks are mostly operated mechanically by using a key to rotate a lock core so that beads are moved to be in alignment with recesses to allow the lock to be unlocked. Once the key is lost or stolen, the lock cannot be unlocked.

In order to improve the inherent shortcoming, a lock that is unlocked and locked by using a remote control is developed. The frequency or electric waves between the remote controls and the locks are designed to be matched to unlock or lock the locks. Nevertheless, the remote controls may be affected by magnetic waves and become functionless. Therefore, how to protect the remote controls from being magnetically affected is an important concern.

The present invention intends to provide a protection container for remote controls, and the cover of the container is equipped with a combination lock or a conventional lock, and the material of the container prevent magnetic waves from affecting the remote controls stored in the protection container.

### SUMMARY OF THE INVENTION

The present invention relates to a protection container for remote controls and comprises a magnetic-proof container having a room defined therein and the room communicates with a top opening. A first flange extends upward from the periphery of the top opening of the container, and at least two paths are defined in the outside of the first flange. Two holes each are defined between two respective ends of the at least two paths and communicate with the room. An entrance is formed above each of the holes corresponding thereto.

A magnetic-proof cover is removably mounted to the top opening of the container. A second flange and a protrusion respectively extend from the underside of the cover, and a groove is defined between the second flange and the protrusion. A lock unit is located in the protrusion and comprises two insertions which are retractably connected to the outside of the protrusion. At least two guide members protrude from the inner periphery of the second flange and are located in the groove. A cable is connected to the top of the cover and connected to the lock unit.

When the cover is mounted to the top opening of the container, the first flange is inserted into the groove, and the at least two guide members pass through the two entrances and move along the at least two paths, and the two insertions are inserted into the two holes.

Preferably, the container includes an annular rib extending from the outside thereof. The lower end of the cover contacts the annular rib when the cover is mounted to the open top of the container.

Preferably, the container and the cover are made by high-carbon steel.

Preferably, the lock unit comprises a disk unit, a keyed lock and an switch unit. The disk unit controls the insertions to retract inward. A connection member is connected between the keyed lock and the disk unit. The keyed lock controls the insertions to retract inward as well. The switch unit controls the cable to be secured to or separated from the cover.

Preferably, the disk unit includes a control button which protrudes through an aperture of the cover. The control button controls setting of the disk unit.

The primary object of the present invention is to provide a protection container for remote controls wherein the cover and the contain are both made by high-carbon steel so as to protect the remote controls in the container from being affected by magnetic waves. The cover has to be rotated relative to the container to retract the two insertions to be engaged with the holes to increase difficulties for theft actions.

The present invention will become more apparent from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the protection container for remote controls of the present invention;

FIG. 2 shows the container and the cover of the protection container for remote controls of the present invention;

FIG. 3 is an exploded view of the protection container for remote controls of the present invention;

FIG. 4 shows that the cover is to be mounted to the container of the protection container for remote controls of the present invention;

FIG. 5 shows that the guide members of cover move along the paths of the container of the protection container for remote controls of the present invention;

FIG. 6 shows that the cover is rotated relative to the container of the protection container for remote controls of the present invention;

FIG. 7 shows that the guide members of cover move to the end of each rail of the container of the protection container for remote controls of the present invention, and

FIG. 8 shows that the remote controls in the protection container is protected being affected by magnetic waves from outside of the container.

### DETAILED DESCRIPTION OF THE PREFERRED EMBODIMENT

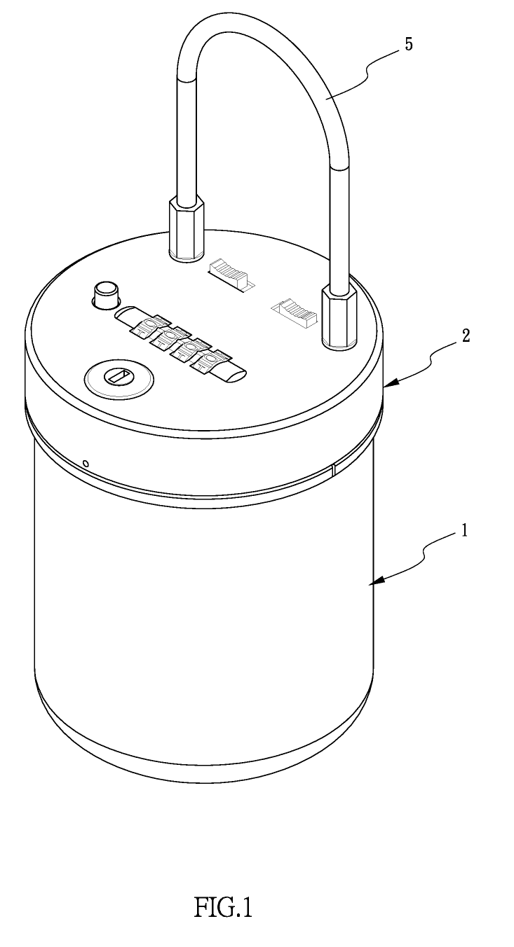

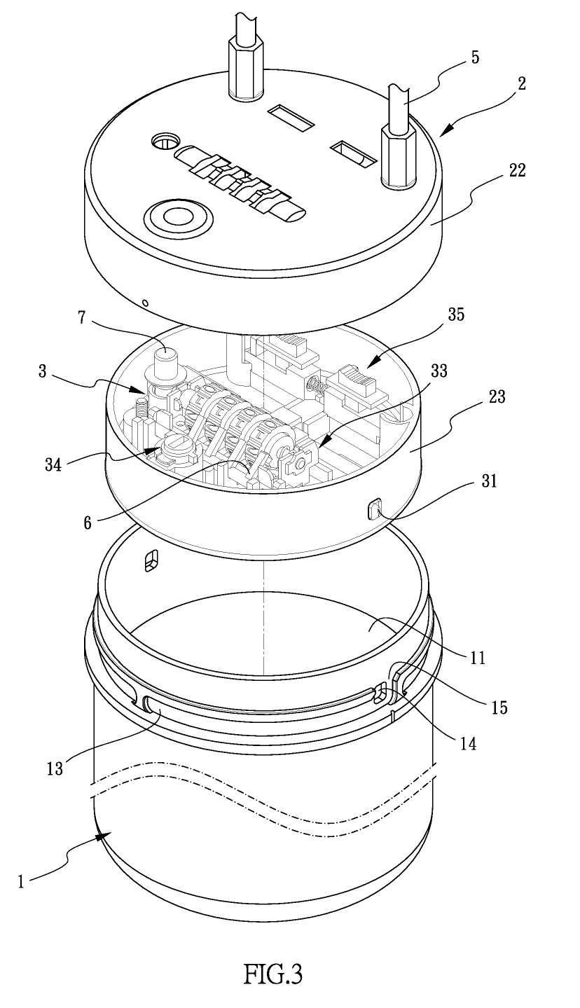

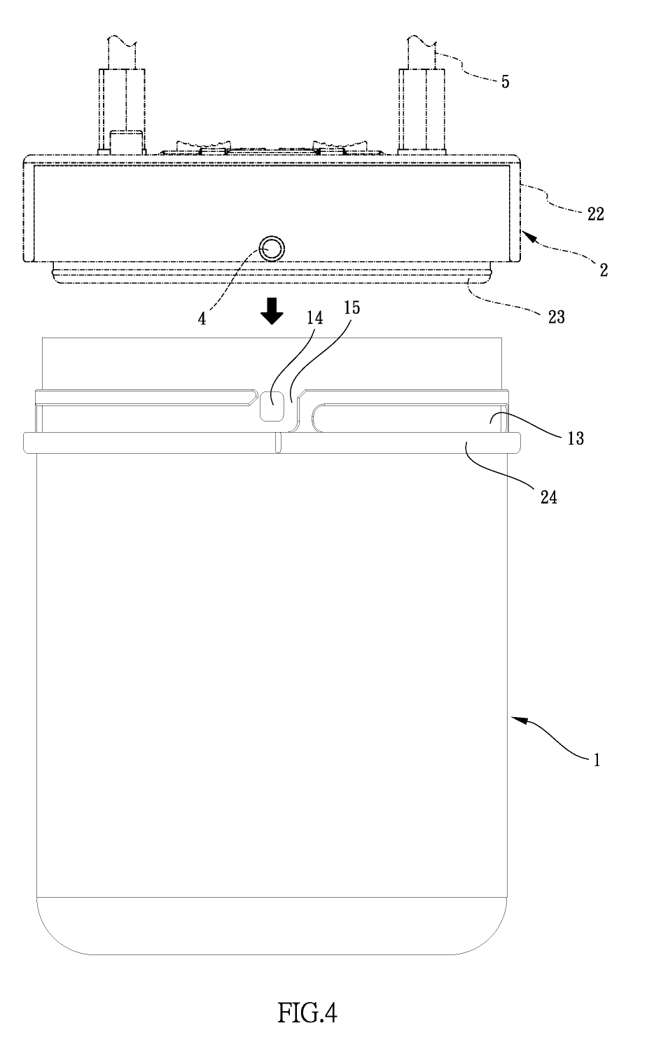

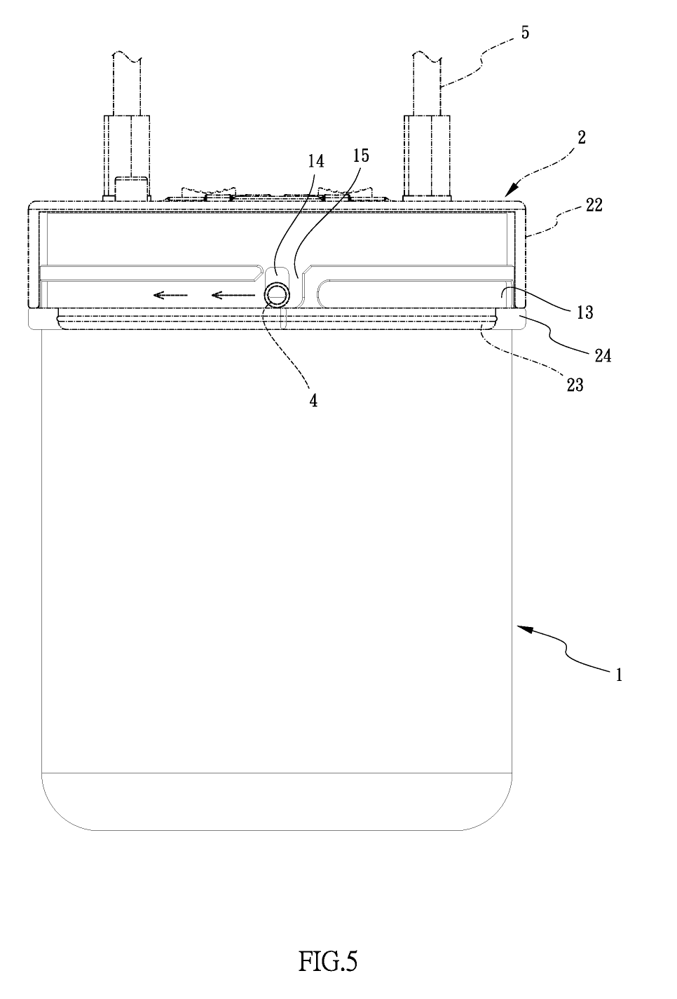

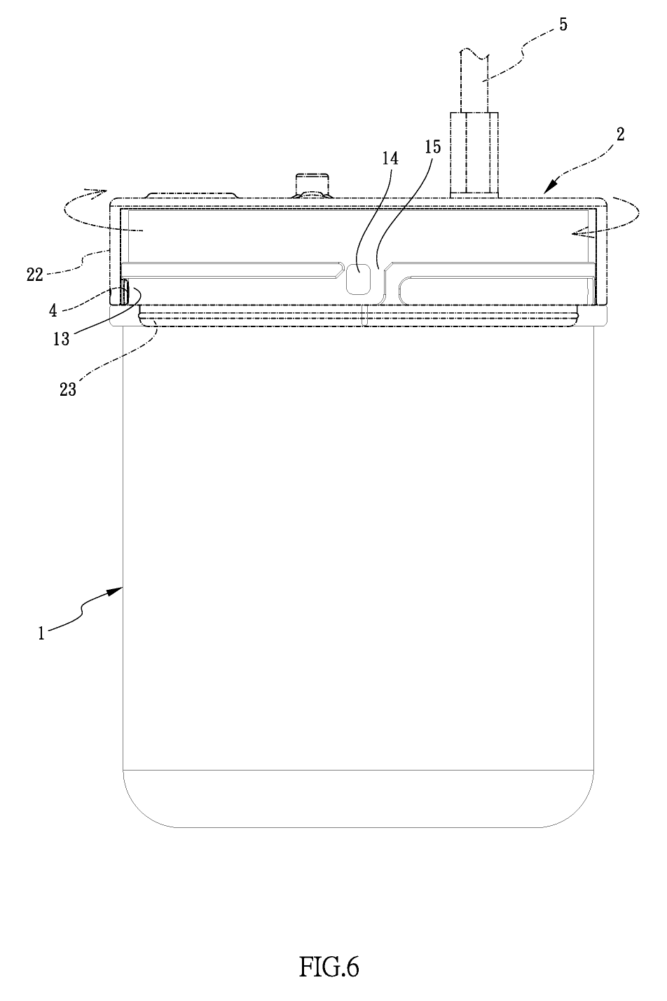

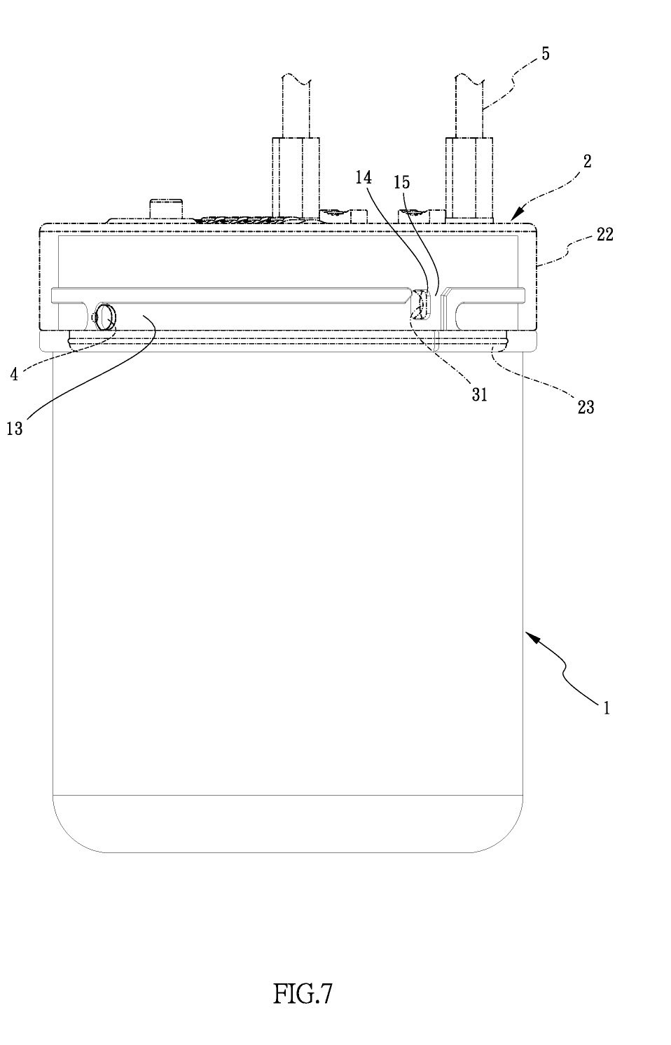

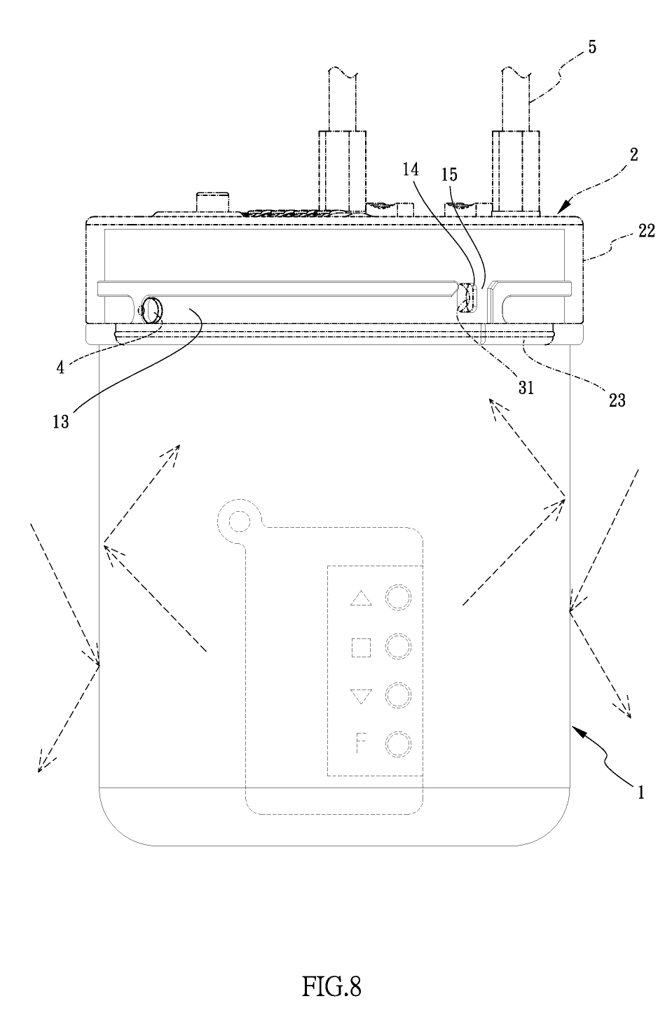

Referring to FIGS. 1 to 8, the protection container for remote controls of the present invention comprises a cylindrical magnetic-proof container 1 having a room 11 defined therein and the room 11 communicates with a top opening. A first flange 12 extends upward from the periphery of the top opening of the container 1. Two paths 13 defined in the outside of the first flange 12. Two holes 14 are defined through the wall of the first flange 12, and each of the two holes 14 is located between two respective ends of the two paths 13. An entrance 15 is formed above each of the holes 14 corresponding thereto. The container 1 further includes an annular rib 24 extending from the outside thereof.

A magnetic-proof cover 2 is made by high-carbon steel, and shaped to be removably mounted to the top opening of the container 1. A second flange 22 and a cylindrical protrusion 23 respectively extend from the underside of the cover 2. An annular groove 21 is defined between the second flange 22 and the protrusion 23. When the cover 2 is mounted to the top opening of the container 1, the first flange 12 is inserted into the groove 21, and the lower end of the cover 2 contacts the annular rib 24.

A lock unit 3 is located in the protrusion 23 and comprises two insertions 31 which are retractably connected to the outside of the protrusion 23.

The lock unit 3 comprises a disk unit 33, a keyed lock 34 and a switch unit 35. The disk unit 33 includes multiple disks which are rotatably accessed from the top of the cover 2, and the disk unit 33 controls the insertions 31 to retract inward. A connection member 6 is connected between the keyed lock 34 and the disk unit 33. The keyed lock 34 controls the insertions 31 to retract inward as well. In other words, when a correction combination is input by operating the disk unit 33, or a correct key is used to unlock the keyed lock 34, because the connection member 6 is connected between the keyed lock 34 and the disk unit 33, the insertions 31 are retracted inward. The switch unit 35 controls the cable 5 to be secured to or separated from the cover 2.

Two guide members 4 protrude from the inner periphery of the second flange 22 and are located in the groove 21. When the cover 2 is mounted to and rotated relative to the top opening of the container 1, the two guide members 4 pass through the two entrances 15 and move along the paths 13. The two insertions 31 are inserted into the two holes 14 to secure the cover 2 when the cover 2 is mounted to the container 1. A cable 5 is connected to the top of the cover 2 and connected to the lock unit 3.

When the remotes are received in the room 11 of the container 1, the user aligns the guide members 4 with the entrances 15, and the first flange 12 is inserted into the groove 21, and the guide members 4 pass through the entrances 15 and enter into the paths 13. The user then rotates the cover 2 and the guide members 4 move along the paths 13 until the guide members 4 reach the respective ends of the two paths 13. The two insertions 31 of the lock unit 3 are inserted into the two holes 14 by operating the lock unit 3 to secure the cover 2 relative to the container 1. One end of the cable 5 is bale to be unleashed relative to the cover 2 by operating the switch unit 35. When the disk unit 33 is under unlock status, the cable 5 can be secured to or separated from the cover 2 by operating the switch unit 35. On the contrary, when disk unit 33 is under locked status, the cable 5 cannot secured to or separated from the cover 2 by operating the switch unit 35. Therefore, the user can hang the protection container on the door handles and wheels or any other object.

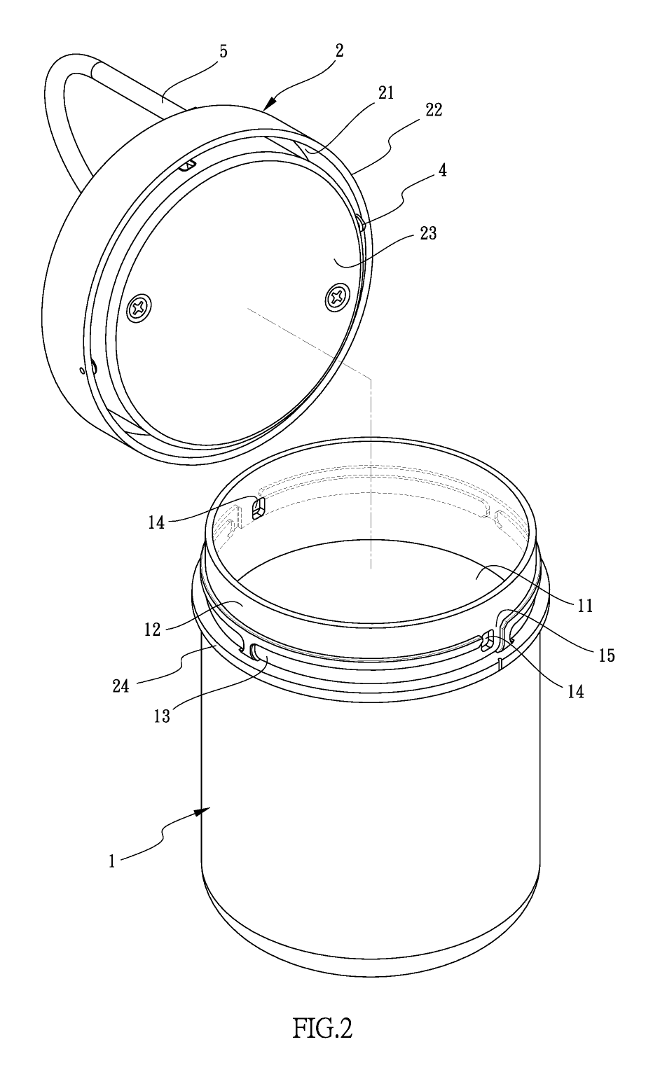

The container 1, the first flange 12 and the annular rib 24 are integrally made as a one-piece, and the two paths 13, the holes 14 and the entrances 15 are also integrally formed with the contain re1. The annular rib 24 restricts the depth that the cover 2 is mounted to the contain re1 so as to prevent the protrusion 23 from hitting the remote controls received in the room 11 of the container 1 as shown in FIG. 2.

The material for the container 1 and the cover 2 is high carbon steel and may include other metal elements such as Chromium, Vanadium, Tungsten or Molybdenum to form Cr23C6, V4C3, Mo2C and WC. The alloys effectively prevent the remote controls from being affected by magnetic waves from outside of the protection container. Furthermore, the disk unit 33 includes a control button 7 which protrudes through an aperture of the cover 2. The control button 7 is pushed to change the setting of the disk unit 33 such that the combination of the disk unit 33 cannot be guessed or figured out.

While we have shown and described the embodiment in accordance with the present invention, it should be clear to those skilled in the art that further embodiments may be made without departing from the scope of the present invention.

What is claimed is:

1. A protection container for remote controls, comprising:
a magnetic-proof container having a room defined therein and the room communicating with a top opening, a first flange extending upward from a periphery of the top opening of the container, at least two paths defined in an outside of the first flange, two holes each defined between two respective ends of the at least two paths, the two holes communicating with the room, an entrance formed above each of the holes corresponding thereto;
a magnetic-proof cover removably mounted to the top opening of the container, a second flange and a protrusion respectively extending from an underside of the cover, a groove defined between the second flange and the protrusion, a lock unit located in the protrusion and comprising two insertions which are retractably connected to an outside of the protrusion, at least two guide members protruding from an inner periphery of the second flange and located in the groove, when the cover is mounted to the top opening of the container, the first flange is inserted into the groove, and the at least two guide members pass through the two entrances and move along the at least two paths, and the two insertions are inserted into the two holes, and
a cable connected to a top of the cover and connected to the lock unit.

2. The protection container for remote controls as claimed in claim 1, wherein the container includes an annular rib extending from an outside thereof, a lower end of the cover contacts the annular rib when the cover is mounted to the open top of the container.

3. The protection container for remote controls as claimed in claim 1, wherein the container and the cover are made by high-carbon steel.

4. The protection container for remote controls as claimed in claim 2, wherein the container and the cover are made by high-carbon steel.

5. The protection container for remote controls as claimed in claim 1, wherein the lock unit comprises a disk unit, a keyed lock and an switch unit, the disk unit controls the insertions to retract inward, a connection member is connected between the keyed lock and the disk unit, the keyed lock controls the insertions to retract inward, the switch unit controls the cable to be secured to or separated from the cover.

6. The protection container for remote controls as claimed in claim 5, wherein the disk unit includes a control button which protrudes through an aperture of the cover, the control button controls setting of the disk unit.
